(19) United States
(12) Patent Application Publication
(10) Pub. No.: US 2017/0163699 A1
(43) Pub. Date: Jun. 8, 2017

(54) STREAMING MEDIA TRANSMISSION SYSTEM, METHOD AND DATA DISTRIBUTION SERVER

(71) Applicants: NANNING FUGUI PRECISION INDUSTRIAL CO., LTD., Nanning (CN); HON HAI PRECISION INDUSTRY CO., LTD., New Taipei (TW)

(72) Inventor: Chih-Chin Chang, New Taipei (TW)

(21) Appl. No.: 14/980,795

(22) Filed: Dec. 28, 2015

(30) Foreign Application Priority Data
Dec. 4, 2015 (TW) 104140664

(51) Int. Cl. H04L 29/06; H04L 29/12; H04L 29/08

(52) U.S. Cl. CPC H04L 65/4069; H04L 67/2842; H04L 61/2007; H04L 67/1095; H04L 61/6068

(57) ABSTRACT

A streaming media transmission system includes at least one customer terminal, a data source server and a number of data distribution servers. The customer terminal, the data source server and the data distribution server forms a tree structure. When the data source server receives a request of a streaming media from a customer terminal, the data source server transfers the streaming media to the data distribution servers connected to the data source server. The data distribution server includes a duplication module, a determining module and a distribution module. The determining module determines whether the customer terminal is a branch node of the data distribution server. When the customer terminal is a branch node of the data distribution server, the duplication module duplicates the streaming media and the distribution module distributes the streaming media to child nodes of the data distribution server. A streaming media transmission method is also provided.

### CROSS-REFERENCE TO RELATED APPLICATIONS

This application claims priority to Taiwan Patent Application No. 104140664, filed on Dec. 4, 2015, the contents of which are incorporated by reference herein.

### FIELD

The subject matter herein relates to a streaming media transmission system.

### BACKGROUND

When streaming medias are transferred from a source terminal to a customer terminal, the streaming media goes through multi-level intermediate nodes. When an intermediate node receives the streaming media, the intermediate node decodes the streaming media and stores the decoded streaming media to its data buffer cache for later use. Then the intermediate node encodes the streaming media in the buffer and transfers the encoded streaming media to a next node. Thus, during the streaming media transmission, the streaming media transmission must be decoded and encoded many times, which consumes a lot of time before the streaming media reaches the customer terminal.

### BRIEF DESCRIPTION OF THE DRAWINGS

Implementations of the present technology will now be described, by way of example only, with reference to the attached figures.

FIG. 1 is a diagrammatic view of a streaming media transmission system.

FIG. 2 is a block diagram of the streaming media transmission system of FIG. 1.

FIG. 3 is a flowchart of a streaming media transmission method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

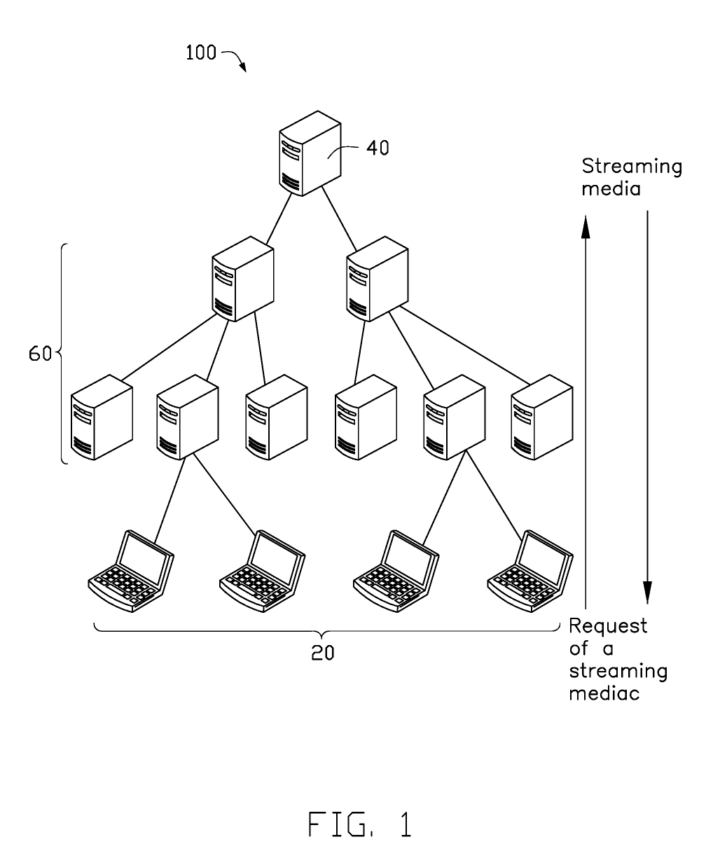

FIG. 1 illustrates a streaming media transmission system 100. The streaming media transmission system 100 includes a number of customer terminals 20, a data source server 40 and a number of data distribution servers 60. The customer terminals 20, the data source server 40 and the data distribution servers 60 form a tree structure. The data source server 40 is a root node of the tree structure. The customer terminals 20 are leaf nodes of the tree structure. The number of data distribution servers 60 form multi-level intermediate nodes between the data source server 40 and the customer terminals 20. Each data distribution server 60 has address information of its father node and its branch node(s). The address information includes IP address and port number. The data distribution server 60 is configured to transmit a request of a streaming media from a customer terminal 20 to the source server 40 and transmit the streaming media from the source server 40 to the customer terminal 20.

The customer terminal 20 transmits a request of a streaming media and its IP address to the source server 40 through the data distribution server 60. When the source server 40 receives the request of the streaming media, the source server 40 transmits the streaming media and the IP address of the requested customer terminal 20 to the data distribution server 60 connected to the source server 40.

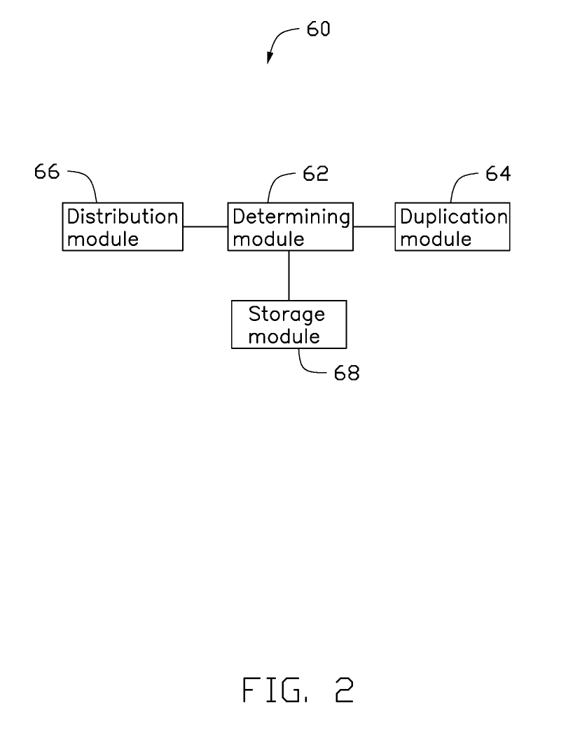

FIG. 2 illustrates each data distribution server 60 including a determining module 62, a duplication module 64, a distribution module 66 and a storage module 68. A processor in the data distribution server 60 for executing programs associated with the determining module 62, the duplication module 64, and the distribution module 66. The storage module 68 is a memory in the data distribution server 60. The determining module 62 is configured to determine whether the requested customer terminal 20 is a branch node of data distribution server 60 according to the IP address of the requested customer terminal 20 transmitted from a father node of the data distribution server 60 and the address information of branch node(s) of the data distribution server 60. When the requested customer terminal 20 is a branch node of the data distribution server 60, the duplication module 64 duplicates the streaming media, and the distribution module 66 distributes the streaming media and the IP address of the request customer terminal 20 to child node(s) of the data distribution server 60.

When the requested customer terminal 20 is a branch node of the data distribution server 60, the storage module 68 stores the duplicated streaming media in a data buffer cache of the data distribution server 60. When the requested customer terminal 20 is not a branch node of the data distribution server 60, the storage module 68 stores the streaming media transmitted from the father node of the data distribution server 60 in the data buffer cache of the data distribution server 60.

In another embodiment, when the source server 40 receives the request of the streaming media, the source server 40 further transmits IP address of the source server 40 to the data distribution server 60 connected to the source server 40. When the requested customer terminal 20 is a branch node of the data distribution server 60, the distribution module 66 further transmits the IP address of the source server 40 to the child node(s) of the data distribution server 60.

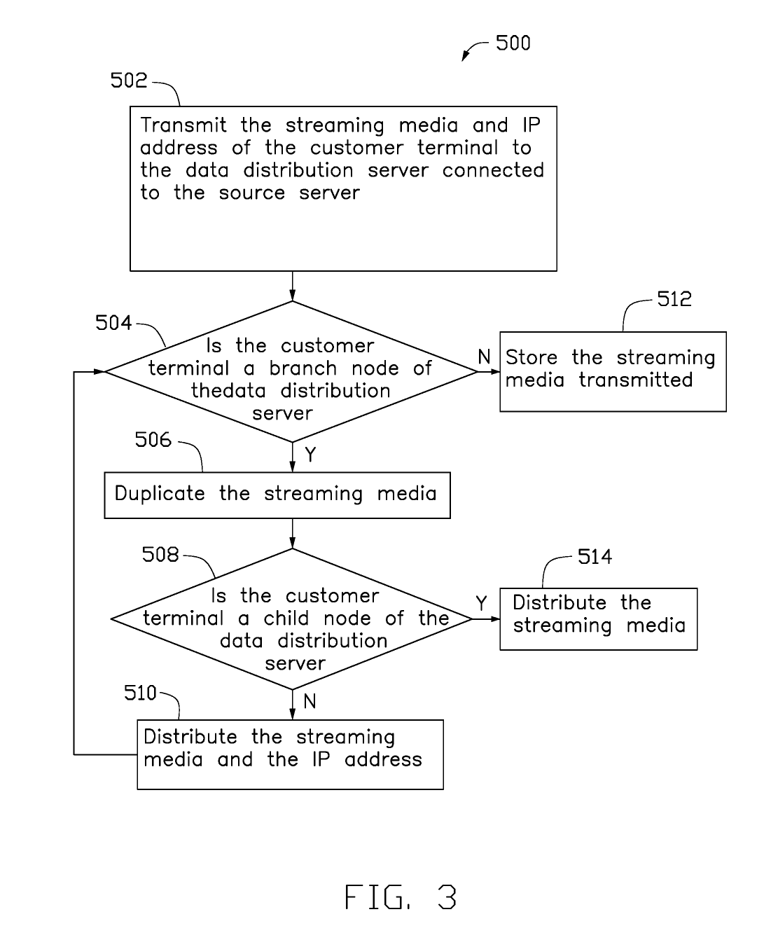

FIG. 3 illustrate a flowchart of a streaming media transmission method. The streaming media transmission method is employed in a streaming media transmission system 100. The streaming media transmission system 100 includes a number of customer terminals 20, a data source server 40 and a number of data distribution servers 60. The customer terminals 20, the data source server 40 and the data distribution servers 60 form a tree structure. The data source server 40 is a root node of the tree structure. The customer terminals 20 are leaf nodes of the tree structure. The number of data distribution servers 60 form multi-level intermediate nodes between the data source server 40 and the customer terminals 20. The streaming media transmission method is configured to transmit a streaming media from the source server 40 to the customer terminal 20. The streaming media transmission method 500 illustrated order of blocks in FIG. 3 is illustrative only and the order of the blocks can change. Additional blocks can be added or fewer blocks may be utilized without departing from this disclosure. The example method can begin at block 502.

At block 502, when the source server 40 receives a request of a streaming media from a customer terminal 20, the source server 40 transmits the streaming media and IP address of the customer terminal 20 to the data distribution server 60 connected to the source server 40.

At block 504, the data distribution server 60 determines whether the customer terminal 20 is a branch node of the data distribution server 60. If the customer terminal 20 is a branch node of the data distribution server 60, the procedure goes block 506, and otherwise the procedure goes block 512.

At block 506, the data distribution server 60 duplicates the streaming media.

At block 512, the data distribution server 60 stores the streaming media transmitted from the father node of the data distribution server 60 in a data buffer cache of the data distribution server 60.

At block 508, the data distribution server 60 determines whether the customer terminal 20 is a child node of the data distribution server 60. If the customer terminal 20 is not the child node of the data distribution server 60, the procedure goes block 510, and otherwise the procedure goes block 514.

At block 510, the data distribution server 60 distributes the streaming media and the IP address of the customer terminal 20 to child nodes of the data distribution server 60.

At block 514, the data distribution server 60 distributes the streaming media to the customer terminal 20.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A streaming media transmission system comprising:
at least one customer terminal configured to transmit a request for a streaming media including a corresponding IP address and receive the streaming media;
a data source server configured to receives the request of the streaming media and transmit the streaming media and the IP address of the requested customer terminal; and
a plurality of data distribution servers forming a tree structure with the data source server and the at least one customer terminal, wherein the data source server being a root node of the tree structure, the at least one customer terminals being leaf node of the tree structure, and each of the plurality of data distribution servers having address information of a father node and branch nodes, the data distribution server comprising:
a determining module configured to determine whether the requested customer terminal is a branch node of data distribution server according to the IP address of the requested customer terminal transmitted from a father node of the data distribution server and the address information of branch nodes of the data distribution server;
a duplication module configured to duplicate the streaming media when the requested customer terminal is a branch node of the data distribution server; and
a distribution module configured to distribute the streaming media and the IP address of the request customer terminal to child nodes of the data distribution server.
at least one processor for executing programs associated with at least one of the determining module, the duplication module, and the distribution module.

2. The streaming media transmission system as claimed in claim 1, wherein the data distribution server further comprises a storage module, the storage module is configured to store the duplicated streaming media in a data buffer cache of the data distribution server when the requested customer terminal is a branch node of the data distribution server.

3. The streaming media transmission system as claimed in claim 2, wherein when the requested customer terminal is not a branch node of the data distribution server, the storage module stores the streaming media transmitted from the father node of the data distribution server in the data buffer cache of the data distribution server.

4. The streaming media transmission system as claimed in claim 1, wherein the source server further transmits IP address of the source server to the data distribution server connected to the source server, when the requested customer terminal is a branch node of the data distribution server, the distribution module further transmits the IP address of the source server to the child nodes of the data distribution server.

5. The streaming media transmission system in claim 1, wherein the address information comprises IP address and port number.

6. A data distribution server employed in a streaming media transmission system, the streaming media transmission system comprising at least one customer terminal, a plurality of the data distribution servers and the data source server which together forming a tree structure, the data source server being a root node of the tree structure, the at least one customer terminals being leaf node of the tree structure, the data source server receiving a request for a streaming media from a customer terminal and transmit the streaming media and IP address of the requested customer terminal to the data distribution server connected to the data source server, the data distribution server comprising:
a determining module configured to determine whether the requested customer terminal is a branch node of data distribution server according to the IP address of the requested customer terminal transmitted from a father node of the data distribution server and address information of branch nodes of the data distribution server;
a duplication module configured to duplicate the streaming media when the requested customer terminal is a branch node of the data distribution server; and
a distribution module configured to distribute the streaming media and the IP address of the request customer terminal to child nodes of the data distribution server;
at least one processor for executing programs associated with at least one of the determining module, the duplication module, and the distribution module.

7. The data distribution server as claimed in claim 6, further comprising:
a the storage module configured to store the duplicated streaming media in a data buffer cache of the data distribution server when the requested customer terminal is a branch node of the data distribution server.

8. The data distribution server as claimed in claim 7, wherein when the requested customer terminal is not a branch node of the data distribution server, the storage module stores the streaming media transmitted from the father node of the data distribution server in the data buffer cache of the data distribution server.

9. A streaming media transmission method employed in a streaming media transmission system, the streaming media transmission system comprising at least one customer terminal, a plurality of the data distribution servers and the data source server which together forming a tree structure, the data source server being a root node of the tree structure, the at least one customer terminals being leaf node of the tree structure, the streaming media transmission method comprising:
transmitting a streaming media and IP address of a requested customer terminal to the data distribution server connected to the data source server when the data source receives a request of a streaming media from a customer terminal;
duplicating the streaming media and transmitting the streaming media and the IP address of the requested customer terminal to child nodes of the data distribution server when the requested customer terminal is a branch node of data distribution server and the requested customer terminal is not a child node of the data distribution server; and
duplicating the streaming media and distributing the streaming media to the customer terminal when the requested customer terminal is a child node of the data distribution server.

10. The streaming media transmission method as claimed in claim 9, further comprising:
storing the streaming media transmitted from father node of the data distribution server in a data buffer cache of the data distribution server when the requested customer terminal is not a branch node of data distribution server.

11. The streaming media transmission method as claimed in claim 9, further comprising:
storing the duplicated streaming media in a data buffer cache of the data distribution server.
